(19) United States
(12) Patent Application Publication
(10) Pub. No.: US 2012/0153093 A1
(43) Pub. Date: Jun. 21, 2012

(54) Electrical Cable Routing Method

(75) Inventors: Harvey Edward Schmidt, Flossmoor, IL (US); Peter M. Morrison, SR., Park Forest, IL (US); Eric Brian Van Gorp, Schererville, IN (US)

(73) Assignee: MI-JACK PRODUCTS, INC., Hazel Crest, IL (US)

(21) Appl. No.: 12/973,804

(22) Filed: Dec. 20, 2010

(51) Int. Cl. F16L 3/22

(52) U.S. Cl. 248/68.1

(57) ABSTRACT

A cable routing device for segregating and environmentally protecting electrical power cables and control/communication wires. The cable routing device includes a base portion, a first and a second side wall portion that define a channel along with the base portion, an interior insulating wall separating the channel into a first and a second section, and a removable cover portion located opposite the base portion and contacting the first and second sidewalls

### FIELD OF THE INVENTION

This invention pertains to housings for electrical cables in general and, in particular, to a housing that segregates electrical and communication cables and environmentally protects them.

### BACKGROUND OF THE INVENTION

Electrically powered and controlled pieces of machinery such as cranes utilize a large number of power cables and control/communication wires. These cables and wires are required to connect power from the prime mover or power source to the function mechanisms, and to connect the operator commands to the proper control device. These cables and wires may be routed through conduit or conventional cable trays.

Known devices, such as wire trays, that are used for distributing the wiring about a piece of machinery in an orderly manner have disadvantages, including cost and labor associated with their installation. When using a conventional wiring tray, individual cables and wires are usually fastened to the wiring tray through the use of wire ties that are connected to various perforated mounting surfaces in the tray. This is a time consuming, labor intensive process that increases the cost of assembling and erecting heavy machinery such as, for example, a gantry crane.

Additionally, in many cases, power cables must be isolated from communication and control wires in order to avoid electro magnetic interference which acts to degrade the control and communication signals. Often this segregation of the wiring requires the use of separate trays for power and control cables and wires.

For these reasons, a cable routing device that allows for easy routing and segregation of power cables and communication wires while also protecting them from the environment would be an important improvement in the art.

### BRIEF SUMMARY OF THE INVENTION

Disclosed is a cable routing device for segregating and environmentally protecting electrical power cables and control/communication wires. The cable routing device is comprised of a base portion, a first and a second side wall portion that define a channel along with the base portion, an interior insulating wall separating the channel into a first and a second section, and a removable cover portion located opposite the base portion and contacting the first and second sidewalls

### BRIEF DESCRIPTION OF THE DRAWINGS

FIG. 1 is a perspective view showing the disclosed cable routing device positioned on a first side of a beam used with a gantry crane.

FIG. 2 is a perspective view showing the disclosed cable routing device positioned on a second side of a beam used with a gantry crane.

FIG. 3 is a perspective view showing an end of the disclosed cable routing device.

FIG. 4 is a perspective view of a cut-away section of an end of a beam showing the disclosed cable routing device positioned on either side of the beam.

FIG. 5 is a perspective view of the disclosed cable routing device showing a hinged cover in an open position.

### DETAILED DESCRIPTION OF THE INVENTION

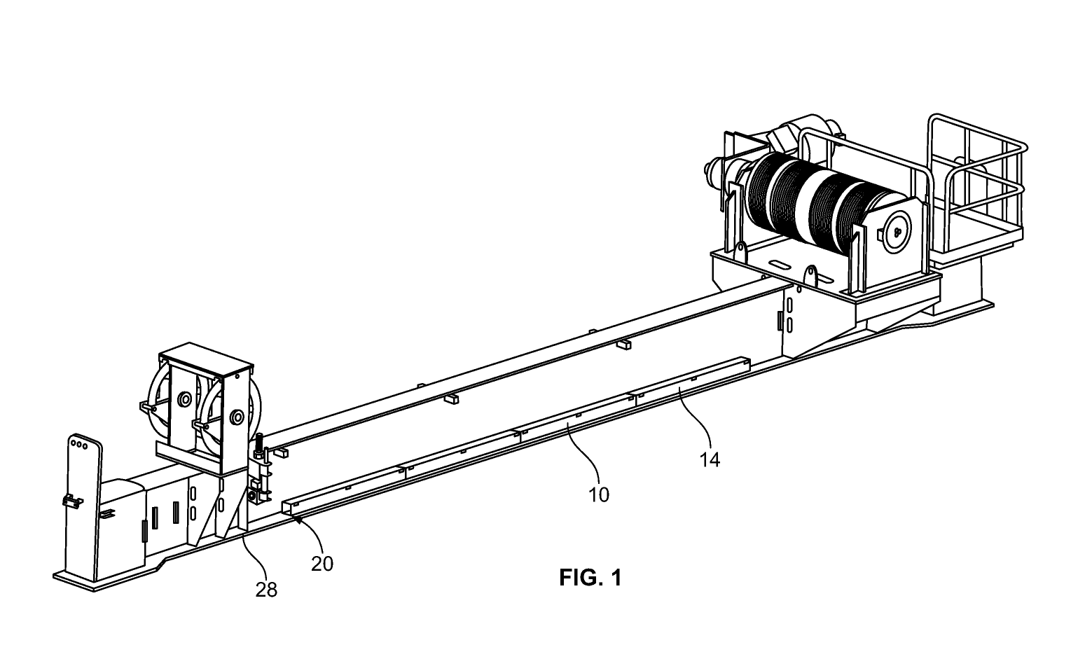

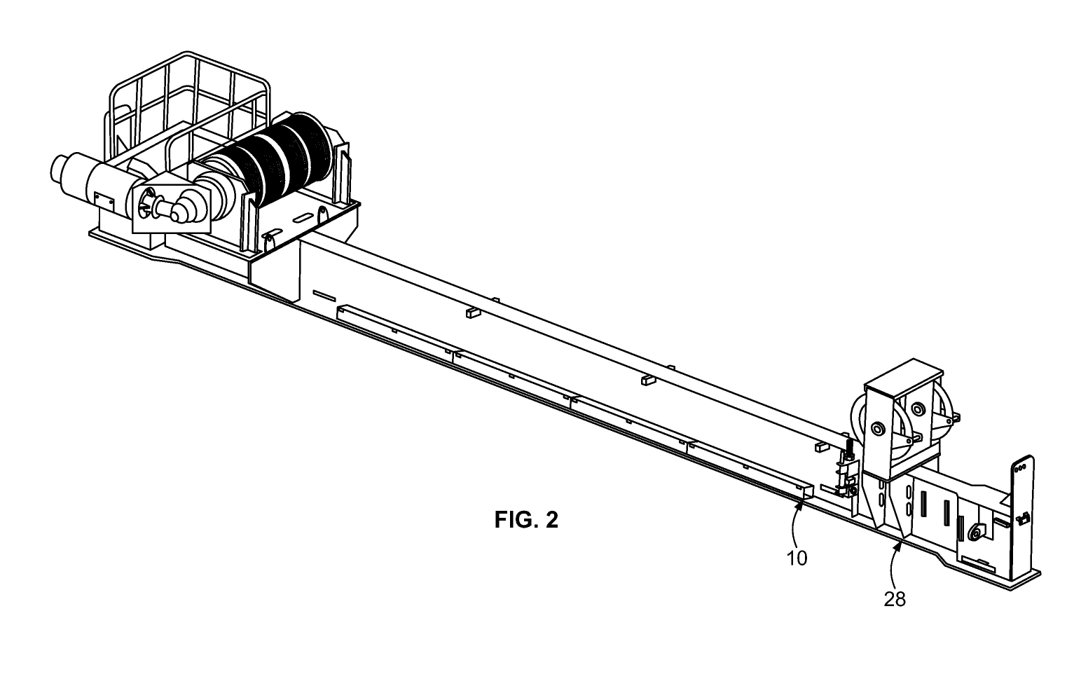

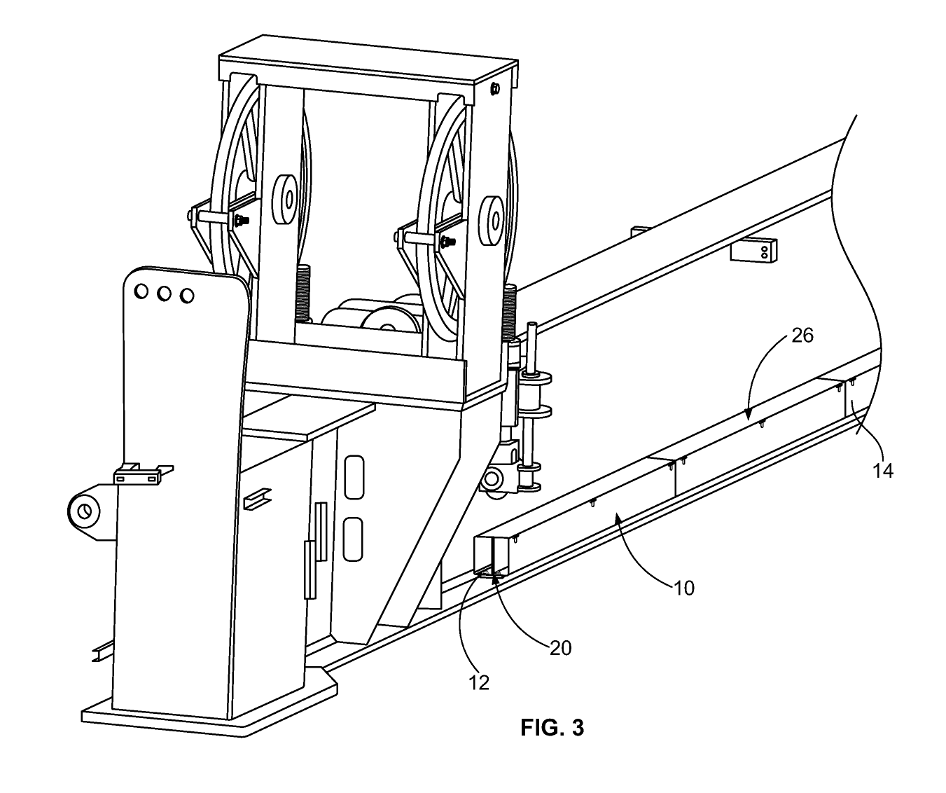

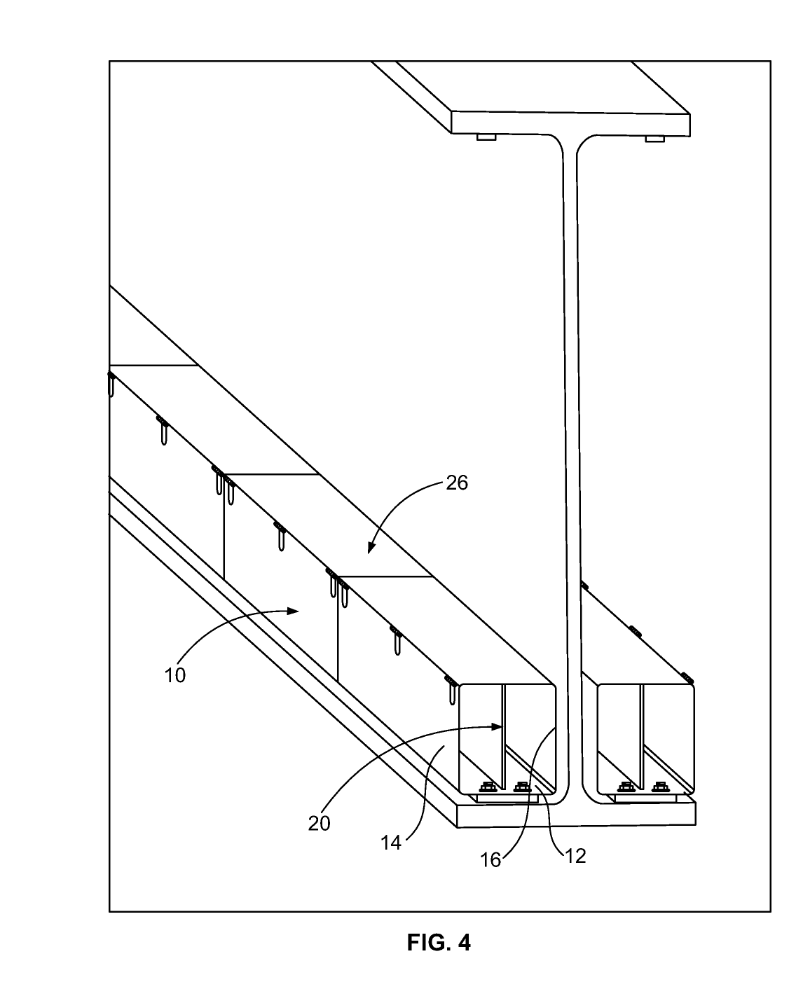

Disclosed is a cable routing device 10 for segregating and environmentally protecting electrical power cables and control; communication wires (not shown). As shown in FIGS. 1-5, the cable routing device 10 is comprised of a base portion 12, a first 14 and a second 16 side wall portion that define a channel 18 along with the base portion 12, an interior insulating wall 20 separating the channel 18 into a first 22 and a second 24 section, and a removable cover portion 26 located opposite the base portion 12 and contacting the first and second sidewalls 14, 16.

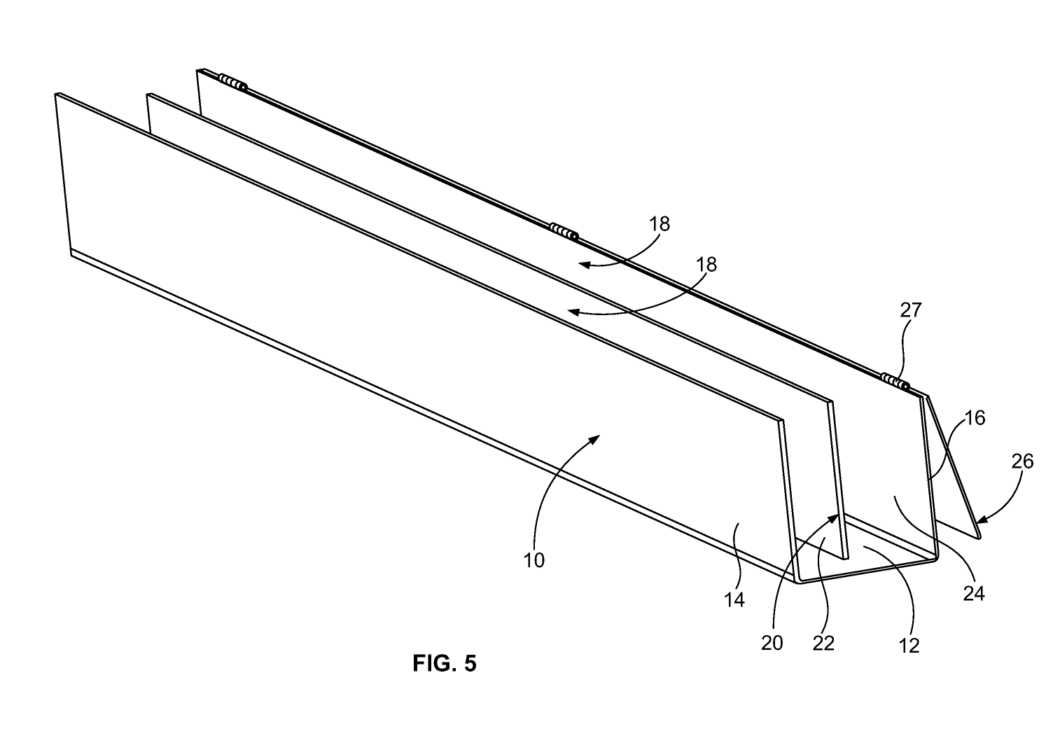

In an embodiment, as shown in FIG. 5, the removable cover 26 is hinged 27 to one of the first and second sidewalls 14, 16 while contacting or being removably connected to the other of the first and second sidewalls 14, 16. When in use, the removable cover 26 is opened and the power cables (not shown) are laid in the first section 22 of the channel 18 and communication and control wires (not shown) are laid in the second section 24. A significant reduction in labor costs is achieved as no wire ties are required to secure the cables and wires within the cable routing device 10, since they remain in their respective channel 18 sections 22, 24, once the removable cover 26 is secured into place over the channel 18. With the cover 26 in place, the cables and wires are protected from UV damage as well as damaged caused by precipitation or other environmental factors.

When in use, the base portion 12 of the cable routing device 10 is mounted on a frame of a machinery piece 28, as shown in FIGS. 1-3. The device 10 can be used with any suitable piece of machinery that requires the routing of numerous power cables and communication/control wires in an orderly manner including, for example, a gantry crane. When used with a gantry crane, the cable routing device 10 can be mounted on any suitable surface including, for example, a top beam 28 of the crane, as shown in FIGS. 1-3.

In an embodiment, the first side wall 14 of the cable routing device 10 has a first height. The second side wall 16 has a second height that is less than the first height, and the removable cover 26 is mounted so as to be slanted from the first sidewall 14 toward the second sidewall 16. In another embodiment, the interior insulating wall 20 is made of a metallic-like material, however, any suitable insulating material may be used without departing from the scope and spirit of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosed cable routing device (especially in the context of the following claims) are to be construed to cover both the singular and the plural, unless otherwise indicated herein or clearly contradicted by context. The use of any and all examples, or exemplary language (e.g., “such as”) provided herein, is intended merely to better illuminate the disclosed cable routing device and does not pose a limitation on the scope of the disclosed cable routing device unless otherwise claimed. No language in the specification should be construed as indicating any non-claimed element as essential to the practice of the disclosed cable routing device.

Preferred embodiments of this cable routing device are described herein, including the best mode known to the inventors for making and using the disclosed cable routing device. It should be understood that the illustrated embodiments are exemplary only, and should not be taken as limiting the scope of the disclosed cable routing device.

What is claimed is:

1. A cable routing device for segregating and environmentally protecting electrical power cables and control/communication wires, the cable routing device comprised of:
a base portion;
a first and a second side wall portion defining a channel along with the base portion;
an interior insulating wall separating the channel into a first and a second section; and
a removable cover portion located opposite the base portion and contacting the first and second sidewalls.

2. The cable routing device of claim 1, wherein:
the removable cover is hinged to one of the first and second sidewalls; and
is removably connected to the other of the first and second sidewalls.

3. The cable routing device of claim 1, wherein:
power cables are laid in the first section of the channel; and
communication and control wires are laid in the second section.

4. The cable routing device of claim 1, wherein the base portion is mounted on a frame of a machinery piece.

5. The cable routing device of claim 4, wherein the machinery piece is a gantry crane.

6. The cable routing device of claim 4, wherein the device is mounted on a top beam of the gantry crane.

7. The cable routing device of claim 1, wherein:
the first side wall has a first height;
the second side wall has a second height that is less than the first height; and
the removable cover is slanted from the first sidewall toward the second sidewall.

8. The cable routing device of claim 1, wherein the routing device is made of a metallic-like material.
